(19) United States
(12) Patent Application Publication
(10) Pub. No.: US 2015/0343636 A1
(43) Pub. Date: Dec. 3, 2015

(54) ROBOT CONTROLLER INTEGRALLY FORMED WITH AMPLIFIER

(71) Applicant: FANUC Corporation, Yamanashi (JP)

(72) Inventors: Shuntaro TODA, Yamanashi (JP); Yoshiki HASHIMOTO, Yamanashi (JP)

(21) Appl. No.: 14/714,970

(22) Filed: May 18, 2015

(30) Foreign Application Priority Data
May 29, 2014 (JP) 2014-111077

(51) Int. Cl. B25J 9/16; G05B 19/414

(52) U.S. Cl. CPC B25J 9/1674; G05B 19/414

(57) ABSTRACT

A robot controller comprises a control unit which outputs a driving command of a servo motor for robot driving, and an amplifier unit which outputs a driving signal to the servo motor in response to the driving command from the control unit. The control unit and the amplifier unit are mounted in integrally formed printed boards and are connected so as to be able to communicate with each other via the printed boards.

### BACKGROUND OF THE INVENTION

1. Field of the Invention

The present invention relates to a robot controller which controls a motor for robot driving via an amplifier.

2. Description of the Related Art

In general, a robot controller includes a servo amplifier for driving a servo motor and a control unit for controlling the servo amplifier. For this kind of robot controller, an apparatus in which a servo amplifier and a control unit (a servo control circuit) are configured to be connected to each other by a cable and to communicate with each other via the cable has been known (for example, Japanese Laid-open Patent Publication No. 6-102912).

However, as in the apparatus disclosed in Japanese Laid-open Patent Publication No. 6-102912, when the servo amplifier and the control unit are configured to be connected to each other via the cable, since an interface for communication is needed to each of the servo amplifier and the control unit as well as the cable, miniaturization and a decrease in cost of an apparatus are disturbed. Furthermore, there is also a problem that time is needed for data communication between the servo amplifier and the control unit.

### SUMMARY OF INVENTION

One aspect of the present invention is a robot controller including a control unit which outputs a driving command of a servo motor for robot driving, and an amplifier unit which outputs a driving signal to the servo motor in response to the driving command from the control unit, wherein the control unit and the amplifier unit are mounted in integrally formed printed boards and are connected so as to be able to communicate with each other via the printed boards.

### BRIEF DESCRIPTION OF THE DRAWINGS

The object, features, and advantages of the present invention will be further apparent from a description of the following embodiment associated with the accompanying drawings, and in the accompanying drawings,

FIG. 1 is a block diagram illustrating a schematic configuration of a robot controller according to an embodiment of the present invention,

FIG. 2 is a diagram illustrating a comparison example of FIG. 1, and

FIG. 3 is diagram illustrating a modified example of FIG. 1.

### DETAILED DESCRIPTION

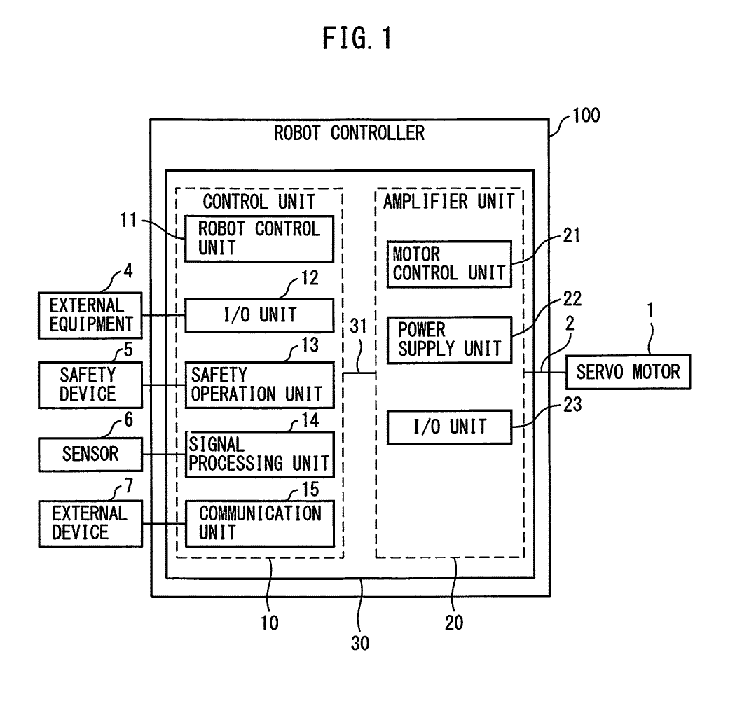

Hereinafter, an embodiment of the present invention will be described with reference to FIG. 1 to FIG. 3.

FIG. 1 is a block diagram illustrating a schematic configuration of a robot controller 100 according to an embodiment of the present invention. The robot controller 100 is connected to a servo motor 1 for robot driving provided in an articulated robot and the like via a cable 2 and controls the servo motor 1, and includes a control unit 10 which outputs a driving command of the servo motor 1 and an amplifier unit 20 which outputs a driving signal to the servo motor 1 in response to the driving command from the control unit 10. The control unit 10 and the amplifier unit 20 are disposed in a housing of the robot controller 100.

The control unit 10 has a robot control unit 11, an I/O (Input/Output) unit 12, a safety operation unit 13, a signal processing unit 14, and a communication unit 15 as functional elements. The robot control unit 11 includes an arithmetic processing device having a CPU (Central Processing Unit), a ROM (Read Only Memory), a RAM (Random Access memory), other peripheral circuits and the like, and performs various types of processing relating to driving control of a robot (the servo motor 1 and the like). The I/O unit 12 is an I/O port and inputs/outputs a signal from an external equipment 4 such as a switch connected to the robot controller 100 to the control unit 10.

The safety operation unit 13 limits the operation of the robot until predetermined safety conditions are satisfied on the basis of a signal from a safety device 5 such as a detector for detecting the presence or absence of an obstacle in an operation range of the robot and an emergency stop switch. The safety operation unit 13 also has a dual check safety function of performing mutual checking an input/output signal between the robot control unit 11 and the safety operation unit 13. The signal processing unit 14 processes (for example, performs image processing and the like) a signal from a sensor 6 such as a visual sensor (a camera) and a force sensor. The communication unit 15 performs communication with various devices 7 (external devices), other than the robot controller 100, such as other robot controllers via the Ethernet (a registered trademark) or a fieldbus.

The amplifier unit 20 has a motor control unit 21, a power supply unit 22, and an I/O unit 23. The motor control unit 21 controls the servo motor 1 on the basis of a signal from an encoder provided in the servo motor 1. The power supply unit 22 supplies driving power to the servo motor 1. The I/O unit 23 includes a circuit for receiving a feedback signal from the servo motor 1, a circuit for controlling a brake of the servo motor 1, a versatile I/O port, and the like, and inputs or outputs a signal to the amplifier unit 20.

The control unit 10 and the amplifier unit 20 are mounted in a single printed board 30, and are connected to each other via a connection unit 31 formed in the printed board 30. A bus wiring is used as the connection unit 31, and the control unit 10 and the amplifier unit 20 are bus-connected to each other. The amplifier unit 20 includes a fan and the like, but since the fan is not mounted in the printed board 30, it is not illustrated in the drawing. In other words, in FIG. 1, only an electronic device mounted in the printed board 30 and performs communication with the control unit 10 is illustrated as the amplifier unit 20.

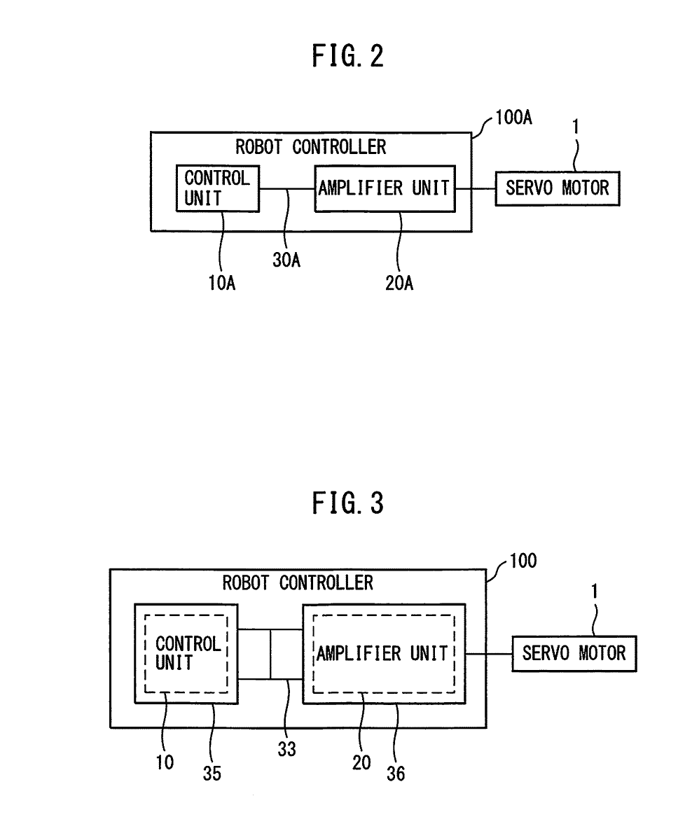

FIG. 2 is a block diagram illustrating a comparison example of the present embodiment. In FIG. 2, a control unit 10A and an amplifier unit 20A are connected to each other via a cable 30A in a robot controller 100A. In such a configuration, an interface for communication is needed to each of the control unit 10A and the amplifier unit 20A as well as the cable 30A. Therefore, the robot controller 100A increases in size and the cost of the apparatus also increases. Furthermore, when communication is performed via the cable 30A, time is needed for data communication.

However, in the present embodiment, as illustrated in FIG. 1, the control unit 10 and the amplifier unit 20 of the robot controller 100 are mounted in the common printed board 30, and are connected to be able to communicate with each other via the printed board 30. Therefore, since the control unit 10 and the amplifier unit 20 are not needed to be connected to each other by the cable 30A and the cable 30A and the interface for communication are not needed, it is possible to achieve the miniaturization and low cost of the robot controller 100. Furthermore, communication of the control unit 10 and the amplifier unit 20 is performed via the connection unit 31 on the printed board 30, so that it is possible to perform data communication at a high speed.

In the present embodiment, the control unit 10 and the amplifier unit 20 are bus-connected to each other, so that it is possible to transmit a large amount of data in a short time. Furthermore, the robot control unit 11, the I/O unit 12, the safety operation unit 13, the signal processing unit 14, and the communication unit 15 are provided to the control unit 10, and functions needed to control the robot are collected in the control unit 10. By adopting this configuration, it is possible to perform communication among the robot control unit 11, the I/O unit 12, the safety operation unit 13, the signal processing unit 14, and the communication unit 15 at a high speed in the control unit 10, and to simplify the configuration of the apparatus.

FIG. 3 is diagram illustrating a modification of FIG. 1. In FIG. 3, the control unit 10 is mounted in a first printed board 35 and the amplifier unit 20 is mounted in a second printed board 36. In other words, the control unit 10 and the amplifier unit 20 are not mounted in the single printed board 30, but are respectively mounted in the printed boards 35 and 36 different from each other. The first printed board 35 and the second printed board 36 are integrally formed with each other via a connector unit 33. The connector unit 33, for example, is a stacking connector, and the control unit 10 and the amplifier unit 20 can communicate with each other via the printed boards 35 and 36 and the connector unit 33.

Also in the example of FIG. 3, since no cable is needed, it is possible to achieve the miniaturization and low cost of the robot controller 100 and to increase communication speed of the control unit 10 and the amplifier unit 20. In addition, also in the example of FIG. 3, the control unit 10 and the amplifier unit 20 are bus-connected to each other.

In addition, in the embodiment (FIG. 1 and FIG. 3), the control unit 10 has the robot control unit 11, the I/O unit 12, the safety operation unit 13, the signal processing unit 14, and the communication unit 15, however, the configuration of the control unit 10 is not limited thereto. For example, it may be possible to employ a configuration in which the control unit 10 includes the robot control unit 11 and at least one of the I/O unit 12, the safety operation unit 13, the signal processing unit 14, and the communication unit 15, such as the robot control unit 11 and the I/O unit 12 or the robot control unit 11 and the communication unit 15.

In the embodiment (FIG. 1 and FIG. 3), the amplifier unit 20 having the motor control unit 21, the power supply unit 22, and the I/O unit 23 is mounted in the printed boards 30 and 36. However, only a part performing communication with the control unit 10 may be mounted in the printed board 30 or 36 integrally formed with the printed board 30 or 35 having the control unit 10 mounted therein, and the configuration of the amplifier unit 20 is not limited the aforementioned embodiment.

In the embodiment (FIG. 1 and FIG. 3), the control unit 10 and the amplifier unit 20 are bus-connected to each other. However, other connection schemes can also be employed if the control unit 10 and the amplifier unit 20 are connected to each other via the printed board 30, 35, or 36 without using a cable. In the embodiment (FIG. 3), the first printed board 35 and the second printed board 36 are connected to each other via the connector unit 33. However, the existing printed boards, in which the control unit 10 and the amplifier unit 20 have been respectively mounted, may also be configured as the first printed board 35 and the second printed board 36, and these two printed boards may also be connected to each other via the connector unit 33. By adopting this configuration, the present invention can also be easily applied to the existing robot controller.

In the embodiment (FIG. 3), the first printed board 35 and the second printed board 36 are configured by single printed boards, respectively. However, any one or both of them can also be configured by a plurality of printed boards. For example, each of the first printed board 35 and the second printed board 36 may be configured by a plurality of printed boards, and the plurality of printed boards may also be integrally formed with each other via a connector.

According to the present invention, since the control unit and the amplifier unit of the robot controller are mounted in the integrally formed printed board and are connected to be able to communicate with each other via the printed board, no cable for connecting the control unit to the amplifier unit is needed. In this way, it is possible to achieve the miniaturization and low cost of the robot controller and to increase communication speed of the control unit and the amplifier unit.

The above description is merely an example, and the present invention is not limited to the aforementioned embodiments and modifications as long as they do not impair the features of the present invention. Elements of the embodiments and the modifications include elements which can be replaced and are apparently replaced while maintaining the identification of the present invention. In other words, other embodiments considered within the technical scope of the present invention are included in the scope of the present invention. Furthermore, the above embodiments and one or more modifications can also be arbitrarily combined.

1. A robot controller including a control unit which outputs a driving command of a servo motor for robot driving, and an amplifier unit which outputs a driving signal to the servo motor in response to the driving command from the control unit, wherein
the control unit and the amplifier unit are mounted in integrally formed printed boards and are connected so as to be able to communicate with each other via the printed boards.

2. The robot controller according to claim 1, wherein the control unit and the amplifier unit are mounted in a single printed board.

3. The robot controller according to claim 1, wherein the control unit and the amplifier unit are respectively mounted in a first printed board and a second printed board which are different from each other, and the first printed board and the second printed board are integrally formed with each other via a connecter unit.

4. The robot controller according to claim 1, wherein the control unit includes a robot control unit which controls a robot, and includes at least one of an I/O unit which inputs or outputs a signal to the control unit, a safety operation unit which limits an operation of the robot until a predetermined condition is satisfied, a signal processing unit which processes a signal from a sensor connected to the robot controller, and a communication unit which performs communication with an exterior of the robot controller.

5. The robot controller according to claim 1, wherein the control unit and the amplifier unit are bus-connected to each other.
